(19) United States
(12) Patent Application Publication
(10) Pub. No.: US 2010/0124725 A1
(43) Pub. Date: May 20, 2010

(54) APPARATUS AND METHOD FOR TOASTING OF BARRELS

(76) Inventor: BRECK WATERMAN, Keswick (AU)

Correspondence Address: WEINER & BURT, P.C., 635 N US-23, POB 186, HARRISVILLE, MI, 48740, US

(21) Appl. No.: 12/271,226

(22) Filed: Nov. 14, 2008

(51) Int. Cl. F26B 3/30; H05B 3/44

(52) U.S. Cl. 432/31; 432/224; 219/553; 392/411; 392/415; 392/432

(57) ABSTRACT

The present invention relates to an apparatus and method for toasting a barrel, in particular, toasting the inside surface of an oak wine barrel. The invention is intended for use in a mobile wine barrel reconditioning system, however, may equally well be used in the manufacture of new barrels. The toasting apparatus includes a plurality of radially disposed infrared heating elements configured to be insertable and removable from inside said barrel, and a means of rotatably oscillating said heating means by a predetermined angle to facilitate uniform heating of said inside surface.

### FIELD OF THE INVENTION

The present invention relates to an apparatus and method of barrel toasting and, in particular, to a mobile system for infrared toasting of barrels. The present invention is intended for particular use in wine barrel reconditioning, but is equally applicable to newly manufactured barrels, and other barrel types.

### BACKGROUND OF THE INVENTION

In the production of barrel staves, oak trees are harvested and the wood is cut or split into shape to be stored and dried for varying lengths of time, up to approximately three years. An oak barrel is formed from these dried staves, with each stave possibly originating from a different oak tree with a different age and moisture content. Oak wood is used for barrels as it contains certain aromatic compounds desirable for wine or other alcohols stored within the barrels. These compounds provide the wine with qualities such as vanilla, smoky and spicy flavours and aromas. The toasting process exposes more of these desirable flavours and aromas in the oak by caramelising sugars, reducing tannin and bitterness, and creating aromatic aldehydes.

Prior to a cooper toasting an oak barrel as an individual and separate process, the staves were traditionally subjected to a heat source in order to enable the construction of the barrel. The staves would be heated and moistened so that they could be more easily bent and metal bands would then be applied to form the barrel shape. At some stage during the history of barrel making, coopers and wine and spirit-makers discovered that the toasting process enhanced the flavour of the wine produced and hence they sought to develop processes where this enhanced flavour was consistently achieved.

The toasting process typically involves placing a barrel over a heat source, generally a furnace, for a particular length of time. The heat source applied to the interior surface of the barrel alters the chemical composition of the oak wood, bringing out different flavours and aromas. Different compounds are released or increased in concentration within the wood depending on whether these compounds were initially found in the wood and the toasting intensity and duration. The toasting intensity, or temperature of the target surface, is of particular importance in producing these compounds and for consistency, the temperature needs to be monitored.

The extent of barrel toasting has traditionally been determined on a barrel by barrel basis, by a cooper, according to winemakers' specifications. The cooper draws upon his/her experience in order to determine the length of time and intensity of heat the barrel should be subjected to, so that it is subjected to a reasonably consistent toast.

The flavours and aromas, formed by the chemical compounds found in the oak after toasting, then become available for extraction by the wines or alcohols stored within the barrel. The amount of flavours and aromas found in the wood depends on the extent that this chemical alteration process has permeated the wood and is determined by the length of time the oak is subjected to the heat source, as well as the intensity of the heat source and the moisture content of the wood.

Wine and spirit-makers are seeking deeper penetration depths for the chemical alteration of the wood as this allows for more flavours to be extracted over a longer period of time. It has been found that up to 70% of the oak's flavours are extracted from the wood in the first year of aging wine in that barrel, with the remaining flavours surface extracted at an exponentially reducing rate.

These traditional methods of toasting are not highly uniform or reproducible. The cooper needs to use his/her expertise to build a fire to what is perceived as the desired temperature and place the barrel over the fire for a desired length of time. The cooper then may rotate the barrel about its central axis, flip it over or moisten the barrel in order to maintain the desired heat and moisture levels for consistent barrel toasting and chemical alteration. If the cooper subjects the barrel surface to too much heat in one particular area by not turning or flipping the barrel over, the wood can burn and form blisters. These blisters are undesirable as they affect the sanitation of the barrel by allowing the stored wine to reside behind the blistered and splintered wood. Conversely, too little heat results in not enough flavours and aromas being extracted by the wine or spirit.

Advancements on the traditional methods of toasting have attempted to standardise the heating and moisturising processes. One method is to rotate the barrel at a constant speed, about a centrally located heat source, thus ensuring that consistent surface toasting occurs. Also, additional moisture may be added at predetermined intervals to assist with the consistent production of flavours and aromas.

In summary, existing toasting apparatus and methods have a number of drawbacks, including but not limited to the following:
Lack of uniformity. Current heating methods are often not capable of producing uniform heat over the entire inside surface of the barrel.
Lack of repeatability. Temperature is not easily controllable (in particular when using an open flame), and therefore repeating a toasting process in exactly the same way as a previous toast is almost impossible.
Lack of mobility. Current toasting apparatus are timely and cumbersome to prepare for use (in particular apparatus involving an open flame). The present applicant is the owner of a co-pending patent application involving a mobile system for reconditioning used barrels, and existing apparatus are not suitable for use in such systems.

It is therefore an object of the present invention to overcome the aforementioned problems or to at least provide the public with a useful alternative.

### SUMMARY OF THE INVENTION

Therefore in one form of the invention there is proposed an apparatus for toasting an inside surface of a wooden barrel, said apparatus including:

a heating means configured to be insertable and removable from inside said barrel; and
a means of rotatably oscillating said heating means by a predetermined angle to facilitate uniform heating of said inside surface.

Preferably said heating means is in the form of a plurality of elongate vertical heating elements radially disposed about a central vertical axis.

In preference the temperature of heat delivered by each heating element is controllable.

Preferably each heating element is separated by an equal radial angle.

Preferably said predetermined angle of rotation corresponds with said equal radial angle by which said heating elements are separated.

In preference wherein said apparatus includes six parallel heating elements separated by a radial angle of sixty degrees.

Preferably each heating element is housed between end portions of a frame associated therewith.

Preferably said frame is configured to direct heat from said heating element to a predetermined radial area of said barrel inside surface.

Preferably said frame includes a portion having a substantially V-shaped cross section which extends behind said heating element whereby an apex thereof is directed toward the central vertical axis.

In preference an inside surface of said V-shaped frame portion is reflective to intensify the heat delivered by said heating elements.

In preference each frame is fixed between upper and lower co-axial circular plates, said lower plate being rotatable about a base plate adapted to be fixed to the ground during operation.

Preferably each heating element is of a length corresponding with the height of said barrel.

Preferably said heating means is in the form of an infrared heater.

In a further form of the invention there is proposed a method of toasting an inside surface of a wooden barrel, said method involving the steps of:

inserting a heating means into position within said barrel to heat said inside surface; and
rotatably oscillating said heating means by a predetermined angle during operation.

Preferably said heating means is in the form of a plurality of elongate vertical heating elements radially disposed about a central vertical axis.

In preference the temperate of heat delivered by each heating element is controllable and adapted to be raised at a predetermined rate until a predetermined inside surface temperature is reached.

Preferably each heating element is separated by an equal radial angle.

Preferably said predetermined angle of rotation corresponds with said equal radial angle by which said heating elements are separated.

### BRIEF DESCRIPTION OF THE DRAWINGS

The accompanying drawings, which are incorporated in and constitute a part of this specification, illustrate several implementations of the invention and, together with the description, serve to explain the advantages and principles of the invention. In the drawings:

FIG. 1 illustrates a perspective view of an apparatus for toasting a barrel in accordance with the present invention;

FIG. 2 illustrates a perspective view of the toasting apparatus of FIG. 2 when placed inside a barrel ready for use;

FIG. 3 illustrates a top view of the toasting apparatus and barrel of FIG. 2 during operation; and

FIG. 4 illustrates a top view of the toasting apparatus and barrel of FIG. 2 and, in particular, the oscillatory motion of the infrared heating elements.

### DESCRIPTION OF THE PREFERRED EMBODIMENTS

The following detailed description of the invention refers to the accompanying drawings. Although the description includes exemplary embodiments, other embodiments are possible, and changes may be made to the embodiments described without departing from the spirit and scope of the invention.

The present invention relates to an apparatus 10 and method for toasting a barrel 12, in particular, toasting the inside surface 14 of an oak wine barrel 12. The invention is intended for use in a mobile wine barrel reconditioning system, however, may equally well be used in the manufacture of new barrels.

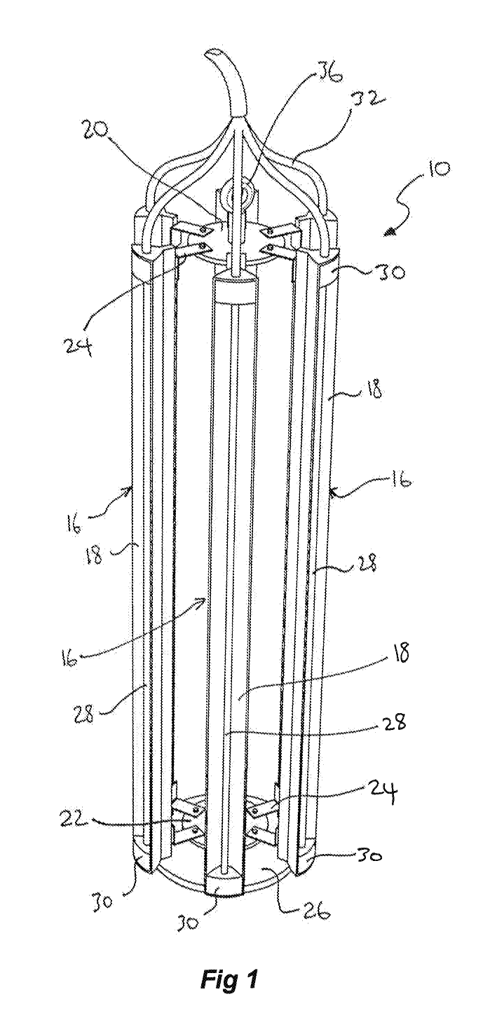

The apparatus 10 is shown in FIG. 1 and includes six radially disposed electric infrared heaters 16 which are configured to rotatably oscillate inside the barrel 12 and thereby heat the inside surface 14 evenly. Each heater 16 oscillates by an angle according to their radial separation. For example, in the embodiment shown, the apparatus 10 includes six heaters 16 which oscillate by approximately sixty degrees, that is, the heaters rotate clockwise by sixty degrees, then anticlockwise by sixty degrees, and this motion is repeated throughout the duration of toasting.

Each heater 16 includes a frame 18 mounted vertically between upper and lower circular plates 20 and 22 respectively, using perpendicular brackets 24. The lower plate 22 is rotatably supported above a circular base plate 26 enabling rotational motion of the heaters 16 in a carousel-type manner. Each frame 18 includes a substantially V-shaped cross section and houses longitudinal ends of an infrared heating element 28 within end portions 30 thereof. The perpendicular brackets are fixed to these end portions 30.

Extending upwardly from each end portion is an electric chord 32 for carrying electricity to power each element 28. Although not shown, the chords 32 lead to an external power supply, such as mains power. In a preferred embodiment, there is a control means (not shown) associated with the heaters 16 so that a user can control the amount of power delivered thereto. Therefore, the intensity of each heater 16 can be varied.

In a typical barrel reconditioning process, toasting entails bringing the temperature of the wood up to approximately 170-184 degrees Celcius, and maintaining the wood at that temperature for some 5-6 minutes. In being able to control the power delivered to each heater, a user is offered greater control over this process.

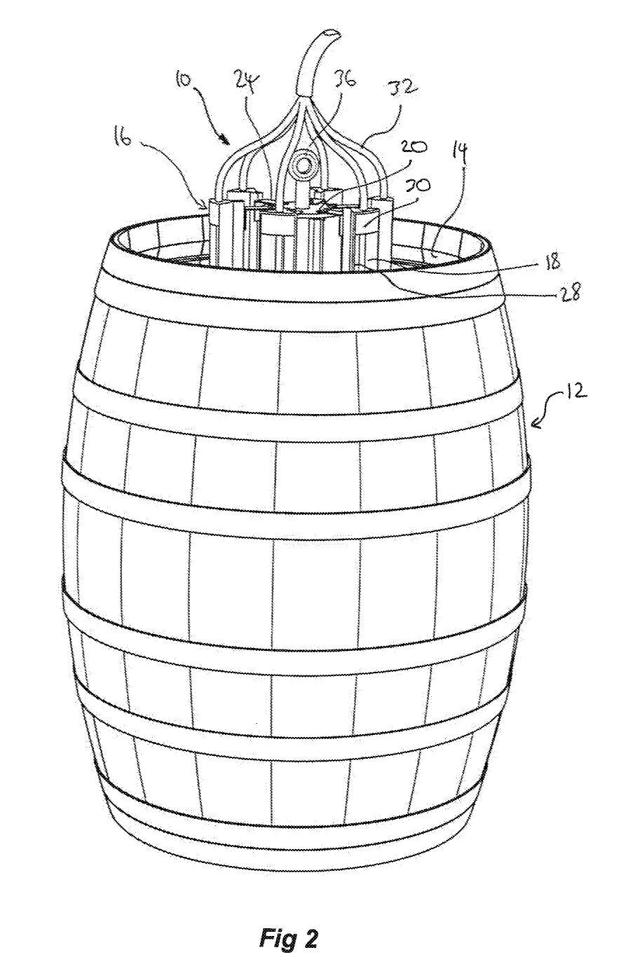

The apparatus 10 is adapted to be placed vertically inside a headless barrel 12 as shown in FIG. 2 so that the base plate 26 sits on the floor and the heaters 16 are positioned in a vertical configuration. The line extending through co-axial centre points of each plate 20 and 22 defines a central vertical axis of the apparatus 10, and each frame 18 is configured to direct heat outwardly from this axis towards the inside surface 14 for toasting. The barrel heads are typically pre-toasted.

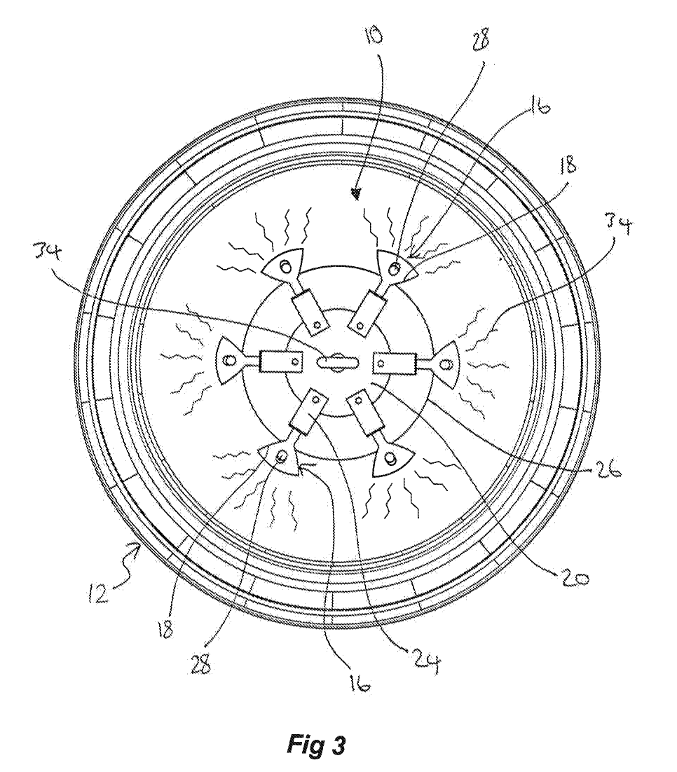

The V-shape of each heater frame 18 ensures that heat is confined to only a predetermined radial portion of the inside surface 14, as well as the vertical height of the barrel (the length of the heating element is approximately the same as the height of the barrel). A top view of the barrel showing infrared rays 34 emanating from each heating element 28 is shown in FIG. 3. In a preferred embodiment, the inside surface of each frame 20 includes reflective plates (not shown) for increasing the intensity of heat emanating from the respective infrared heating elements 28.

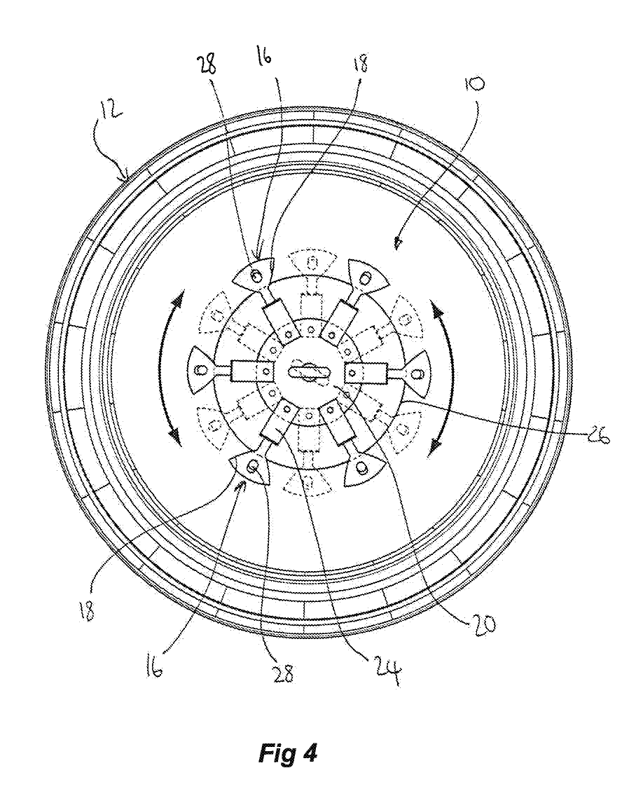

As mentioned, each heater 16 undergoes oscillatory rotation inside the barrel 12 by approximately the same angle as their radial separation. This may be achieved using any suitable driving means. A preferred way is to drive the bottom plate 26 pneumatically. An alternate way that would not be preferred but may still be used could involve engaging a hook 36 associated with the upper circular plate 20 and rotating it clockwise a predetermined angle, then anticlockwise a predetermined angle, and so on. This motion is shown in FIG. 4.

In a preferred embodiment, a pneumatic system using compressed air is used to rotate the heaters 16. For the purpose of brevity, this equipment is not shown in the drawings or described in any detail as it is considered well known to the skilled addressee. A control means would also naturally be associated with the pneumatic rotating means so that it may be rotated to other angles before changing direction, and at different speeds designated by a user.

Although not shown, lowering and raising of the toasting apparatus 10 inside and out of the barrels 12 could be achieved using an electric lift, or the like. Further, the barrels could be moved along a production line whereby one or more toasting apparatus 10 is lowered into and raised out of a plurality of barrels in an automated process. Means to raise the barrel a short distance off the ground could also be used if required.

Those skilled in the art should now realise the benefits of the present invention.

Uniformity is achieved because of the configuration of the heaters 16. The fact that they confine heat to a predetermined radial portion of the inside surface 14, and are rotatably oscillated, ensures an even spread of heat which prevents both blistering and under-toasting.

Repeatability is possible because the intensity of the heaters, as well as the heating time is controllable, which means that once a particular type of barrel has been toasted once, the same settings can be used again for a similar type of barrel. For example, a new barrel may require different toasting settings to a used barrel whose inside surface has just been shaved during reconditioning.

The apparatus 10 of the present invention also addresses the problem of mobility in that it provides a means of bringing a toasting apparatus to a barrel, rather than a barrel to a toasting apparatus. This is particularly relevant in the present case as the Applicant is the owner of a co-pending patent application directed toward a mobile barrel reconditioning system in which a portable means of barrel toasting is required.

It is to be understood that the use of infrared heating elements is by way of example only, and that other controllable heat sources could equally well be used. Furthermore, other equipment for aiding a cooper in toasting the barrel could well be used, such as heat sensors positioned to measure the temperature inside and outside the barrel, and computing means to process and store relevant data from such equipment as the temperature sensors, the heating elements, and any other parameters relating to the toasting process.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus.

In any claims that follow and in the summary of the invention, except where the context requires otherwise due to express language or necessary implication, the word “comprising” is used in the sense of “including”, i.e. the features specified may be associated with further features in various embodiments of the invention.

1. An apparatus for toasting an inside surface of a wooden barrel, said apparatus including:
a heating means configured to be insertable and removable from inside said barrel; and
a means of rotatably oscillating said heating means by a predetermined angle to facilitate uniform heating of said inside surface.

2. An apparatus as in claim 1 wherein said heating means is in the form of a plurality of elongate vertical heating elements radially disposed about a central vertical axis.

3. An apparatus as in claim 2 wherein the temperature of heat delivered by each heating element is controllable.

4. An apparatus as in claim 2 wherein each heating element is separated by an equal radial angle.

5. An apparatus as in claim 4 wherein said predetermined angle of rotation corresponds with said equal radial angle by which said heating elements are separated.

6. An apparatus as in claim 2 wherein said apparatus includes six parallel heating elements separated by a radial angle of sixty degrees.

7. An apparatus as in claims 2 wherein each heating element is housed between end portions of a frame associated therewith.

8. An apparatus as in claim 7 wherein said frame is configured to direct heat from said heating element to a predetermined radial area of said barrel inside surface.

9. An apparatus as in claim 7 wherein said frame includes a portion having a substantially V-shaped cross section which extends behind said heating element whereby an apex thereof is directed toward the central vertical axis.

10. An apparatus as in claim 9 wherein an inside surface of said V-shaped frame portion is reflective to intensify the heat delivered by said heating elements.

11. An apparatus as in claim 7 wherein each frame is fixed between upper and lower co-axial circular plates, said lower plate being rotatable about a base plate adapted to be fixed to the ground during operation.

12. An apparatus as in claims 2 wherein each heating element is of a length corresponding with the height of said barrel.

13. An apparatus as in claim 1 wherein said heating means is in the form of an infrared heater.

14. A method of toasting an inside surface of a wooden barrel, said method involving the steps of:
inserting a heating means into position within said barrel to heat said inside surface; and
rotatably oscillating said heating means by a predetermined angle during operation;

15. A method as in claim 14 wherein said heating means is in the form of a plurality of elongate vertical heating elements radially disposed about a central vertical axis.

16. A method as in claim 15 wherein the temperate of heat delivered by each heating element is controllable and adapted to be raised at a predetermined rate until a predetermined inside surface temperature is reached.

17. A method as in claim 15 wherein each heating element is separated by an equal radial angle.

18. A method as in claim 17 said predetermined angle of rotation corresponds with said equal radial angle by which said heating elements are separated.
